(19) United States
(12) Patent Application Publication
(10) Pub. No.: US 2003/0023593 A1
(43) Pub. Date: Jan. 30, 2003

(54) Real-time adaptive data mining system and method

(76) Inventor: Richard Schmidt, Huntington, NY (US)

Correspondence Address: Michael J. Scheer, DICKSTEIN SHAPIRO MORIN & OSHINSKY LLP, 41st Floor, 1177 Avenue of the Americas, New York, NY, 10036-2714, US

(21) Appl. No.: 10/151,814

(22) Filed: May 22, 2002

Related U.S. Application Data
(63) Continuation-in-part of application No. 09/854,337, filed on May 11, 2001.
(60) Provisional application No. 60/203,216, filed on May 11, 2000.
(60) Provisional application No. 60/293,234, filed on May 23, 2001.

(51) Int. Cl. G06F 7/00

(52) U.S. Cl. 707/6

(57) ABSTRACT

A set of rules generated from data examples describing a situation can be created and updated according to new information received in real time. The set of rules provides a description of a domain of knowledge based on logical conclusions that can be drawn from the data. The rules are mutually exclusive, and are reduced to a minimized set that completely represents the data to which the rules are exposed. The outcome of the rules is adoptive to changing data and sensitive to shifts in the conclusions that can be drawn about the data. More recently received data is more heavily weighted than prior data to permit a rapid response to information shifts.

### RELATED APPLICATIONS

This is a continuation in part application based on Utility Application No. 09/854,337, filed May 11, 2001, entitled SYSTEM AND METHOD OF DATA MINING which is based upon and claims benefit of Provisional Application No. 60/203,216, filed May 11, 2000, and is also based upon and claims benefit of Provisional Application No. 60/293,234, filed May 23, 2001, upon all of which a claim of priority is hereby made. Utility Application No. 09/854,337, filed May 11, 2001 is hereby incorporated into the present application in its entirety.

### FIELD OF THE INVENTION

The present invention relates generally to a system and method of data mining. More specifically, the present invention is related to a system and method for deriving adaptive knowledge based on pattern information obtained from data collected in real time.

### BACKGROUND OF THE INVENTION

Data mining takes advantage of the potential intelligence contained in the vast amounts of data collected by business when interacting with customers. The data generally contains patterns that can indicate, for example, when it is most appropriate to contact a particular customer for a specific purpose. A business may timely offer a customer a product that has been purchased in the past, or draw attention to additional products that the customer may be interested in purchasing. Data mining has the potential to improve the quality of interaction between businesses and customers. In addition, data mining can assist in detection of fraud while providing other advantages to business operations, such as increased efficiency. It is the object of data mining to extract fact patterns from a data set, to associate the fact patterns with potential conclusions and to produce an intelligent result based on the patterns embedded in the data. These fact patterns associated with conclusions can be directly applied in an expert system, thus providing an automated process for expert system development.

Typically, a large amount of data is collected and then examined for patterns related to knowledge contained within the data. Presently available commercial software generally relies on statistical methods to associate patterns in the data with knowledge that is representative of conclusions about the factual situation that the data represents. The Induction of Decision Trees (ID3) method or Chi Squared Automatic Interaction Detection (CHAID) algorithm are examples of statistical techniques to derive knowledge from information patterns contained within a set of collected data. These methods and algorithms used statistical techniques to determine which attributes of the data are related to significant conclusions that can be drawn about the data. However, these algorithms are generally based on a linear analysis approach, while the data is generally non-linear in nature. The application of these linear algorithms to non-linear data can typically only succeed if the data is divided into smaller sets that approximate linear models. This approach may compromise the integrity of the original data patterns and may make extraction of significant data patterns problematic.

Neural networks and case based reasoning algorithms may also be used in data mining processes. Known as machine learning algorithms, neural nets and case based reasoning algorithms are exposed to a number of patterns to “teach” the proper conclusion given a particular data pattern.

However, neural networks have the disadvantage of obscuring the patterns that are discovered in the data. A neural network simply provides conclusions about which of the neural network patterns most closely matches patterns in newly presented data. The inability to view the discovered patterns limits the usefulness of this technique because there is no means for determining the accuracy of the resultant conclusions other than by actual empirical testing. In addition, the neural network must be “taught” by being exposed to a number of patterns. However, in the course of teaching the neural network as much as possible about patterns in data to which it is exposed, over-training becomes a problem. An over-trained neural network may have irrelevant data attributes included in the conclusions, which leads to poor recognition of relevant data patterns when the neural network is presented with new data patterns to analyze.

Case based reasoning also has a learning phase in which a known pattern is compared with slightly different, but similar patterns, to produce associations with a particular data case. When new data patterns are applied to such a system, the case based algorithm evaluates groups of learned patterns with close similarities to the attributes of the new data applied to the system. As with CHAID, this method also suffers from a dependence on the statistical distribution of data used to train the system, resulting in a system that may not discover all relevant patterns.

The goal of data mining is to obtain a certain level of intelligence regarding customer activity based on previous activity patterns present in a data set related to a particular activity or event. Intelligence can be defined as the association of a pattern of facts with a conclusion. The data to be mined is usually organized as records containing fields for each of the fact items and an associated conclusion. Fact value patterns define situations or contexts within which fact values are interpreted. Some fact values in a given pattern may provide the context in which the remaining fact values in the pattern are interpreted. Therefore, fact values given an interpretation in one context may receive a different interpretation in another context. As an example, a person approached by stranger at night on an isolated street would probably be more wary than if approached by the same person during the day or with a policeman standing nearby. This context sensitivity complicates the extraction of intelligence from data, in that individual facts cannot be directly associated with conclusions. Instead, fact values must be taken in context when associations are made.

Each field in a record can represent a fact with a number of possible values. The permutations that can be formed from the number of possible associations between n fact items is N1*N2*N3* . . . *Ni* . . . *Nn, where each Ni represents the number of values that the fact item can assume. When there are a large number of fact items, the number of possible associations between the fact items, or patterns, is very large. Most often, however, all possible combinations of fact item values are not represented in the data. As a practical matter, the number of conclusions or actions associated with the fact item patterns is normally a small number. A large number of data records are normally required to ensure that the data correctly represents true causality or associative quality between all the fact items and the conclusions. The large number of theoretically possible patterns, and the large number of data records makes it very difficult to find patterns that are strongly associated with a particular conclusion or action. In addition, even when the amount of data is large, all possible combinations of values for fact items 1 through n may still not be represented. As a result, some of the theoretically possible patterns may not be found in the patterns represented by data.

Statistical methods have been used to determine which fact item (usually referred to as an attribute) has the most influence on a particular conclusion. A typical statistical method divides the data into two groups according to a value for a particular fact item. Each group will have a different conclusion, or action, associated with the grouping of values related to the conclusion or action in the data for that group. Each subgroup is again divided according to the value of a particular fact item. The process continues until no further division is statistically significant, or at some arbitrary level of divisions. In dividing the data at each step, evidence of certain patterns can be split among the two groups, reducing the chance that the pattern will show statistical significance, and hence be discovered.

Once the division of the data is complete, it is possible to find patterns in the data that show significant association with conclusions in the data. Normally, the number of actual patterns, although larger than the number of conclusions, is a small fraction of the possible number of patterns. A greater number of patterns with respect to conclusions or actions may indicate the existence of irrelevant fact items or redundancies for some or all of the conclusions. One can omit irrelevant fact items from a pattern without affecting the truth of the association between the remaining relevant fact items and the respective conclusion. A pattern with omitted fact items thus becomes more generalized, representing more than one of the possible patterns determined by all fact items.

However, when a decision of irrelevancy is made based on statistical methods, patterns which occur infrequently may be excluded as being statistically irrelevant. In addition, an infrequently occurring pattern may have diminished relevancy when the data is divided into groups based on more frequently occurring patterns. Moreover, if a statistic based effort is made to collect and examine patterns which occur infrequently, some patterns may be included that indicate incorrect conclusions. Inclusion of these incorrect patterns may lead to a condition known as over-fitting of the data.

Another difficulty in this field is that examples of all conclusions of interest may not be present in the data. Since statistical methods rely on examples of patterns and their associated conclusions to discover data patterns, they can offer no help with this problem.

The above-described approaches to data mining operate on sets of data that have been amassed over time and that are generally static in nature. For example, the statistical methods operate on the data on a whole to produce statistical conclusions for specific patterns in the data. The approaches that adopt a machine learning algorithm, such as the neural networks and case based reasoning techniques, require exposure to a large number of data examples to produce useful results. Each of these systems described above is typically unsuitable for use in a real time framework to discover patterns within data being received in response to presently occurring real world situations. In addition to the difficulties discussed above with regard to statistical and machine learning algorithms, the above-described approaches are ill suited to handle dynamic information that is characteristic of real time data mining. Since the abovedescribed systems are designed to process a known set of static data, they typically respond poorly when new data is introduced to the set being analyzed, especially when new data is introduced on a continual basis. When continuously input dynamic data is considered, a recalculation of results generally must include all data acquired to that point. Accordingly, the above described techniques would require tremendous processing resources to accommodate a real time data mining system. In addition, the result of such a system would exhibit very little impact from most recently acquired data.

U.S. patent application Ser. No. 09/854,337, entitled System and Method of Data Mining, discloses a recent innovation in data mining using a logistical approach rather than a statistical or machine learning algorithm approach. While the logistical data mining approach simplifies and improves upon the extraction of data patterns from a set of accumulated data, the data operated on by the logistical approach is still static in nature. If the logistical technique is applied to a set of data that has a real time element adding to the accumulated data, the impact of the most recent data will again be deemphasized as with the statistical and machine learning algorithms discussed above.

### SUMMARY OF THE INVENTION

It is an object of the present invention to provide a systematic method for the discovery of all patterns in a given set of data that reflect the essence of information or intelligence represented by that data.

A further object of the present invention is to surpass the performance of statistical based data mining methods by detecting patterns that have small statistical support.

It is a further object of the present invention to determine the factors in the data that are relevant to the outcomes or conclusions defined by the data.

A further object of the present invention is to provide a minimal set of patterns that represent the intelligence or knowledge represented by the data.

A further object of the present invention is to indicate missing patterns and pattern overlap due to incomplete data for defining the domain of knowledge.

It is a further object of the present invention to provide a systematic method for the discovery of knowledge derived from data as it is acquired in real time.

It is a further object of the present invention to emphasize knowledge contained in more recently acquired data.

It is a further object of the present invention to provide a method that encompasses broad knowledge domains in a simplified manner that identifies portions of the knowledge contained in the data as it becomes available.

It is a further object of the present invention to provide a method that accommodates the extraction of knowledge from data with probabilistic and/or erroneous associated outcomes or conclusions.

It is a further object of the present invention to provide a method for deriving and using a practical error rate related to the data.

It is a further object of the present invention to provide a method for automatically producing the rules for an expert system.

It is a further object of the present invention to provide a method for continuous automated updating of rules for an expert system.

The present invention uses logic to directly determine the factors or attributes that are relevant or significant to the associated conclusions or actions represented in a set of data. A system and method according to the present invention reveals all significant patterns in the data. The system and method permit the determination of a minimal set of patterns for the knowledge domain represented by the data. The system and method also identify irrelevant attributes in the patterns representing the data. The system and method allow the determination of all the possible patterns within the constraints imposed by the data. Patterns that completely cover all relevant outcomes are detected or identified and recorded.

The present invention directly determines the factors or attributes in the data that are relevant to a representation of the data. Knowledge contained in data acquired in real time is revealed as the significant data patterns are discovered, beginning immediately with initial real time data. Because the system and method of the present invention use logic rather than statistical methods, relevant patterns representative of the knowledge contained in the data are determinable starting with the very first data example provided. As additional data is acquired, attributes irrelevant to the outcomes of the data patterns are removed from the set of attributes in the data pattern. The attributes that are removed from the various data patterns do not contribute to their respective conclusions and are therefore irrelevant. By removing irrelevant attributes from the patterns, the present invention can determine a minimal set of patterns for the knowledge domain represented by the data. As more data is received in real time, all the normally occuring patterns determinable within the constraints imposed by the data are discovered. Accordingly, the present invention provides a system and method for detecting and reporting attribute patterns needed to completely represent all possible patterns representative of the data. By weighing the more recently received data more heavily than prior data, the present invention emphasizes the effect of the more pertinent information that is more recently received. The use of non-linear processing accorded to more recently received data provides a weighting technique that provides emphasis on the more recently received data.

The data provided according to the present invention represents situations and concepts through a set of attribute values associated with an appropriate action or conclusion. A first example of a set of attribute values associated with a conclusion is accepted as a first rule in which the conclusion or action associated with the attribute values is inferred every time that any of those attribute values are encountered in the data. This overly broad rule is normally modified as new examples are processed. As new examples are provided and examined, a comparison is made between the new example and the established rules derived from previous examples.

A new rule is only generated when the example under examination does not match the attribute values of a rule that has already been established. In order to handle data in which situations have probabilistic actions or conclusions, a count for each action/conclusion of each rule is retained. If the attribute values of the example under examination matches an existing rule, a count for actions or conclusions associated with the example is incremented in the rule. The present invention provides a predetermined maximum action or conclusion tally that the count increment may not exceed. If the action or conclusion count is already at a maximum, and an incrementation is indicated by examination of the present example, then the counts for all other actions or conclusions associated with that rule are decremented, with a minimum value for each count being zero. As new examples are compared to the existing rules, inconsistencies in the data can be represented by having several different conclusions or actions associated with a single set of attribute values for a given rule. The action or conclusion for each rule that has the highest count is designated as the predominant action or conclusion for that rule.

When the action or conclusion tally maximum is set to a small number, for example, from about 5 to 10, the system and method according to the present invention will be more responsive in emphasizing recent trend changes in the data. Due to the weighting of the actions or conclusions associated with the attribute values of a particular rule, prior action or conclusion data is retained, but can be emphasized or de-emphasized depending on more recently received data. The action or conclusion that has the highest count in a group of actions or conclusions associated with a given set of attribute values for a rule is designated as the predominant action or conclusion for that rule. Since the count values can change for each of the actions or conclusions in a given rule, it is possible to have several actions or conclusions with the same highest count number. In this case of a tie between the various actions or conclusions for a given rule, the former designated predominant action is preferably retained as the predominant action or conclusion for the specific rule to provide hysteresis for noise suppression.

As the system and process according to the present invention continues to receive data examples, new rules can be formed that are representative of previously undiscovered patterns in the data. When a new rule is formed, a further operation to identify irrelevant attributes and to identify groups of relevant attributes is performed on the rules. Identification of irrelevant attributes and groups of relevant attributes is obtained by comparing the new rule to all the other rules having a different predominant action or conclusion in the set of existing rules. This comparison process may affect the relevance of attributes within existing rules, requiring an update to the existing rules. An update to the existing rules may also be required if there is a shift in the predominant action or conclusion for a given rule brought about by incrementing and decrementing the associated counts for the rule action or conclusion. Once all the rules are updated, a minimal set of mutually exclusive rules, with a set of relevant attributes for each rule, is obtained.

Once the set of mutually exclusive rules with sets of relevant attribute patterns is formed, another rule set can be formed that has all redundancy for each predominant action or conclusion removed. This non-redundant set of rules is determined by expanding each set of relevant attribute values for each rule into a canonical form, which permits redundancy among the rules to be more easily observed. The non-redundant rules contain only relevant attributes, and cover a large portion, if not all, of the possible attribute combinations. Accordingly, these non-redundant rules will typically be small in number, usually much smaller than the possible number of rules that could be generated given the set of all possible attribute values. The present invention thus simplifies the data mining process to provide a concise and highly useful result, without suffering from “the curse of exponential explosion” often mentioned in artificial intelligence literature.

Various subset domains of knowledge can be defined to represent the overall domain of knowledge contained within the data. Each of the subset domains are related to each other in a hierarchy that provides a representation of the overall knowledge domain. By breaking down the overall domain of knowledge into smaller pieces for representation of the data, each of the subset domains can become fully defined as soon as the data related to a given subset domain is received and processed. The subset domains can be generalized in the same way that the rules describing the data are generalized. The subset domains can be mutually exclusive while representing the knowledge related to the overall domain with a minimized set of rules. The results contained within the subset domains can be aggregated or condensed in upper levels of the hierarchy that serves to organize all the subset domains with respect to each other. In addition, the subset domains all typically use the same attributes, even if a number of attributes in the various subset domains are declared irrelevant.

The complete set of non-redundant, mutually exclusive and minimized rules represent all the relevant knowledge contained in the data received to that point. If there is insufficient data to completely define all the rules representative of the data, the rules may exhibit some overlap or gaps. Overlap is observed through rules with different conclusions, yet with the same set of attribute values. Gaps in the data is observed through portions of the domain not covered by any data example. Initially, the method produces a gap with the first data example. The gap can be filled in if desired by adding extrapolated rules determined by the first data example. The second received data example eliminates the gap. These deficiencies can be corrected manually by, for example, an expert familiar with the domain of knowledge. In addition, an expert can select certain classes of examples to effectively orient the creation of rules to a specific subset domain of knowledge. Accordingly, shifts in predominant actions or conclusions for the rules can be achieved to effectively realign the rules for the specific subset domain. Since the process is more sensitive to recently occurring data examples, a realignment of the rules can be forced to occur rapidly.

The system and process generalizes the data presented as representative of a domain of knowledge by calculating and saving intermediate results. Accordingly, an entire set of amassed data can be processed to achieve an intermediate result, that is further adapted upon application of new data examples.

The system and method of the present invention can also handle multi-valued or analog type parameters in a set of attribute patterns representative of a domain of knowledge. The continuous type parameters can be segmented into discrete value ranges, so that multiple attributes represent a single continuous parameter. In a data example, a multi-valued attribute will be assumed to contain a single value. If more than one value is contained in the multi-valued attribute of the example, it will be considered as a separate example for each value. Thus,a new rule will be generated for each of the different values encountered in data examples. If multi-valued attributes are compared between two rules, and the attribute values match, then that specific value of the multi-valued attribute can be declared irrelevant or redundant, rather than the entire multi-valued attribute. Also, if two or more values are in rules with the same conclusion and the rules only differ by those values, the values may be grouped (effectively reducing the dimensionality of the attribute) and the rules combined into one.

### BRIEF DESCRIPTION OF THE DRAWINGS

Details of the above description will become more apparent when read in conjunction with the following detailed description and drawings, in which:

FIG. 1 is a diagram illustrating the steps of the data mining method;

FIG. 2 is a diagram illustrating the step of selecting a data example;

FIG. 3 is a diagram illustrating selection of a domain;

FIG. 4 is a diagram illustrating an overall procedure for processing real-time data examples;

FIG. 5 is a diagram illustrating an update to conclusion counts;

FIG. 6 is a diagram illustrating the removal of redundant rules;

FIG. 7 is a diagram illustrating expansion of the rules into canonical form to facilitate the elimination of redundant rules;

FIG. 8 is an illustration of a data example containing an attribute list and associated action or conclusion; and

FIG. 9 is an example of a canonical expansion of a relevant attribute rule for redundancy checks.

### DETAILED DESCRIPTION OF THE PREFERRED EMBODIMENTS

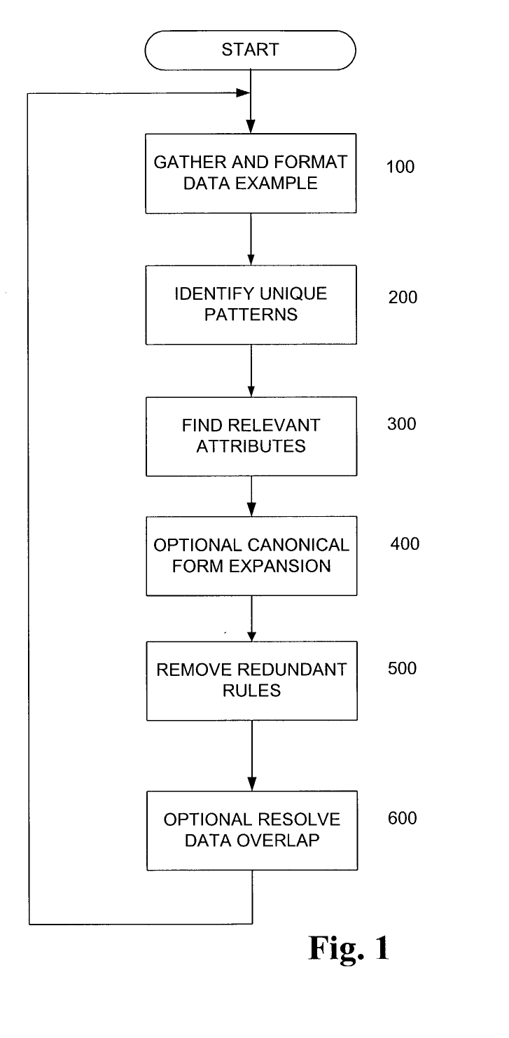

Referring now to FIG. 1, a flow diagram illustrating an overview of the system and method according to the present invention is shown. In an initial step 100, a data example relating to a situation is gathered and formatted for use according to the present invention. The data can be accumulated over a period of time to provide an amassed set of information, or can be processed in individual records as they are generated or received. In a step 200, unique patterns in the data are identified and resolved into rules. Generating the rules in this manner maintains the uniqueness of the patterns represented in the rules. The generation or update of the rules accommodates a single data example at a time when sequentially processing an entire set of amassed data examples or upon receipt of new data when processing in real time.

As rules are generated and updated, relevant attributes for each of the rules are determined in a step 300. Relevant attributes are preferably attributes with values that contribute in some way to the conclusion associated with a given rule. As new data examples are received and processed, shifts may occur in the relevancy of attribute values as conclusions for a rule are updated. Step 300 permits attributes to be identified as relevant or irrelevant to the particular conclusion with which they are associated. The rules can be expanded into a canonical form to more easily identify redundancies in an optional step 400. A step 500 removes redundant rules in the set of rules determined from steps 100-400. Once redundancies are removed from the rules, an optional step 600 permits review of the result to determine if any overlap of information exists between the rules (rules with different conclusions, yet with the same set of attribute values). Overlap between the rules can be resolved with input from an operator, or by obtaining further data examples that can resolve the discrepancies in subsequent process loops. The final result is a set of rules that completely describe the domain of knowledge with no conflicting conditions.

The basic assumption for the system and method of data mining disclosed herein is that all situations and concepts represented by data examples in the form of data records are essentially rules of intelligence. Rules of intelligence can be defined as representing knowledge contained within the data if each rule contains 1) attributes describing a situation or concept, and 2) an appropriate action or conclusion to be taken based on those specific attribute values. It is also assumed that the majority of these data records contain correct actions or conclusions associated with each set of attribute values. That is to say, the conclusion for each associated set of attribute values in a data example is inferred as a correct conclusion in the general case. The data examples may contain errors in the attribute values or the associated conclusions in practice. However, mining knowledge out of the data examples results in a set of rules based on correct, or majority conclusions, for a given data pattern concerning a set of attribute values. In developing these rules based on data mining, the number of erroneous examples related to a particular conclusion preferably do not equal or exceed the number of correct examples for that conclusion in a given sample space of recently received data examples.

Each data example with a set of attribute values and an associated conclusion can be a data record reflecting information related to a situation in everyday life. As the data records are processed, the system and method of the present invention builds a knowledge base representative of the system or concept for which information is collected. The data records are preferably discretely valued, containing a number of discrete attribute values associated with a discrete conclusion. The invention accommodates continuously valued parameters by separating them into discrete ranges of continuous values, for example. If it is known that certain ranges of the continuous value have similar effect, then those ranges may be defined as discrete attribute values. The granularity of the continuous value parameters represented by discrete ranges can be improved by increasing the number of discrete attribute values representing the continuous parameter. In addition, the invention permits multi-valued attributes that can assume a number of discrete values in a range. For example, instead of having an attribute that is binary in nature, a multi-valued attribute can be tertiary or quaternary valued. It should be apparent that any type of attribute configuration can be accommodated in the invention, with the attributes preferably being discretely quantized.

Data records can be analyzed for attribute patterns beginning with the first data received, or in the case of amassed data records, the first data record. In the case of amassed data records, if it is not desired to imply greater importance to the last records analyzed, then that part of the processing can be eliminated or set to have a very high maximum value for conclusion counts. An initial data record is selected for processing, whether it be the first data received in real time, or the first data record taken from a collected set of data records. The information contained in the data record is then compared with subsequent data records to determine whether new information can be obtained through the comparison. A number of data records can be processed in this way, resulting in a set of mutually exclusive rules that each contain a set of attributes and a group of conclusions associated with the specific list of attributes.

The group of conclusions associated with a specific set of attribute values in a given rule generally includes a correct conclusion and several conclusions that reflect alternate conclusions or possible errors in the data (attribute values and/or conclusion). Data errors can generally be manifested in a number of conflicting actions or conclusions for the same set of attribute values. For example, a given rule may represent an attribute pattern that has differing actions or conclusions for the same set of attribute values. The present invention permits the selection of a predominant action by assigning counts to each of the conclusions that occur for a specific set of attribute values in the data records. The conclusion or action associated with a particular set of attribute values that has the highest count value is preferably designated as the predominant action for that set of attribute values.

When the predominant conclusion or action is chosen from a group of conclusions or actions based on the count value associated with that conclusion, there is a statistical impact on the data associated with the knowledge domain. For example, there may be a statistically small occurrence of a particular conclusion that is associated with a set of attribute values that may be of particular interest to the domain of knowledge. If the practical error rate for the data under examination approaches the frequency of occurrence for the infrequently occurring conclusions of interest, these conclusions of interest may be missed altogether. In a situation such as this, the statistical selection of the predominant conclusion based on counts may result in a set of rules that does not contain all the knowledge of interest in representing a domain of knowledge relevant to a given situation.

An example of a data pattern that can typically result in a statistically small, but interesting set of conclusions, is when there is fraud in a transaction. In this instance, the number of transactions that do not contain fraud may be much larger than the number of occurrences of fraudulent transactions. As a result, the number of occurrences of fraudulent transactions appearing in the data may be comparable to the occurrences generated by a practical error rate for the non-fraud data. If it is the fraudulent transactions that are of interest in the particular domain of knowledge, the overwhelming numbers of non-fraudulent transactions, that may include errors that mimic fraudulent transactions, will diminish the significance of the fraudulent transactions. This misinformation will cause fraud rules to be missed or identified as erroneous.

Stated more explicitly, for N overall examples containing n examples of fraud at a naturally occurring frequency, the overall probability of fraud=n/N. As a simplified example, if there are eight binary valued attributes, then there can be 256 different patterns. Say only 4 of the patterns truly represent fraud. If we assume the rest of the patterns are possible, the number of fraud examples may be overwhelmed by erroneous non-fraud examples, if the probability of error, pₑ, is sufficiently large. Assuming an even distribution of examples over all the patterns, then a non-fraud example containing attribute errors mimicking a fraud example will occur sufficiently often to overshadow the fraud conclusion if ((N−n)/(256−4))pₑ>n/4. If N=10⁶, and n=10, then erroneous conclusions or actions which appear to be fraud will compete strongly with correct conclusions or actions if pₑ>63×10⁻⁵.

To avoid the above problem, the relationship between non-fraud examples and fraud examples must be more balanced. The problem can be overcome by reducing the number of non-fraud examples, and/or increasing the number of fraud examples, n. With the number of instances of each conclusion or action occurring in roughly comparable numbers, the examples of interest will occur significantly more often than the erroneous examples. Modifying the selection of data to include more examples of interest and/or to decrease the instances of other conclusions does not change the intelligence content of the data. While a particular portion of the data is given more focus, the underlying and attendant information remains unchanged.

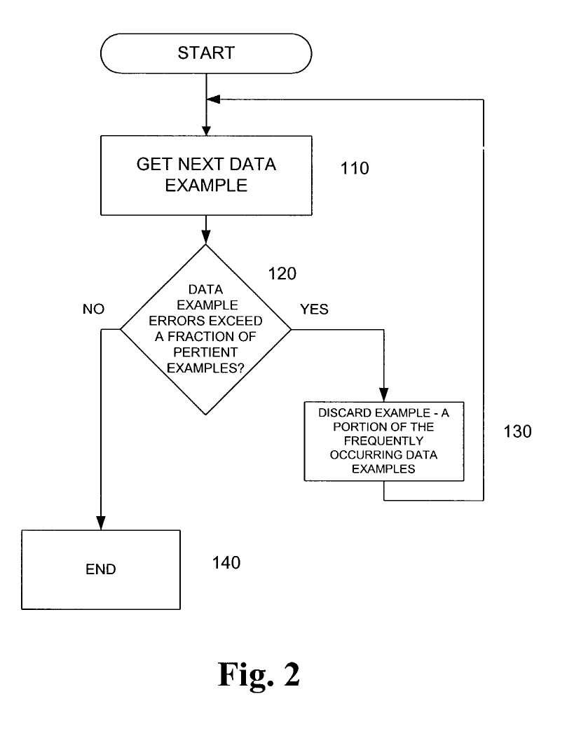

In the instance where it is known apriori that non-fraud examples containing errors may exceed the number of fraud transactions that contain no errors, a portion of the erroneous examples may be discarded to avoid introducing misinformation. Referring now to FIG. 2, an illustration of a flow process for obtaining data that is properly balanced is shown. Information about data error rates and infrequently occurring conclusions is gathered apriori. A next data example is selected in step 110. A decision step 120 determines if the number of data example errors based on the expected error rate exceeds a predetermined fraction of the pertinent examples of interest. If there is no difficulty with an infrequently occurring conclusion being overwhelmed, decision step 120 branches to the “NO” path, and the process ends in a step 140. If the data is unbalanced to the point of missing infrequently occurring conclusions because of the error rate, decision step 120 branches to the “YES” path. A step 130 causes frequently occurring data examples to be discarded to balance the data. This process can also be viewed as sampling the data. Once the data examples are deleted in step 130, the process returns to step 110 to accept the next example. The process in FIG. 2 can be revised if more information about the data becomes available.

It is possible that the data contains non-fraud related examples that have two or more differing conclusions that occur in comparable quantities with respect to each other. In this instance, if non-fraud examples are discarded to balance a relationship between fraud and non-fraud examples, the non-fraud examples should be discarded or sampled to maintain the relative statistical relationship between the non-fraud examples having differing conclusions. Similarly, if there are a number of correct conclusions associated with data examples related to fraud that occur in comparable quantities, none of the fraud related examples should be discarded. In real time processing, fraud or non-fraud will normally not be known reliably until a later time. At that time, correction for an original erroneous conclusion should be made by correcting the conclusion counts (non-fraud and fraud) for the rule that represents the situation.

If it is not known apriori what the patterns of interest are that are included in the data, this sophistication can be programmed according to the present invention by monitoring the number of examples received for each conclusion or action. The present invention then preferably prevents a ratio of the examples from exceeding a value for which a practical error rate would introduce an erroneous conclusion. That is, the greatest number of examples having a specific conclusion do not exceed some multiple of the smallest number of examples having another conclusion that would lead to the introduction of an erroneous conclusion, given the practical error rate for the data.

With apriori knowledge, the number of correct examples and the number of erroneous examples is used to determine the practical error rate. The practical error rate is used to determine the number of expected erroneous examples in a generalized process, in which it can be assumed, if not otherwise known, that there is an even distribution of data errors.

It is preferable according the present invention that useful knowledge contained in the data be extracted with the examination of only a few data examples. When collecting the conclusions or actions associated with a particular attribute value pattern, it is thus preferable that the possible conclusions or actions be maintained at a relatively small number. By limiting the number of conclusions or actions that can be associated with a particular attribute pattern, a number of limited domains of knowledge can be defined that represent the overall knowledge domain. This concept of limited domains of knowledge contained within the overall knowledge domain can reduce the amount of processing required to fully define each of the limited knowledge domains. A further reduction in processing is made possible by removing attributes from data examples in the limited domain that are determined to be irrelevant to that domain. With smaller, limited knowledge domains, a fewer number of data examples can provide useful knowledge about a particular limited domain, permitting that domain to be defined without having to process all of the existing sets of rules containing attribute value sets and associated conclusions.

Multiple domains of knowledge can be represented by separate sets of rules, each separate set of rules being developed using the same methodology. Selection of the appropriate set of rules for a given situation or concept represented by the data can be determined according to a set of selection rules. These selection rules can be developed using the same methodology for determining relevant rules according to the present invention. The resulting hierarchical structure with multiple knowledge domains permits all of the separate sets of rules to be developed concurrently as the data examples are acquired. The selection rules coupled with the separate sets of rules can be placed in a hierarchical construction that can be expanded to as many levels as necessary to represent all the domains of knowledge desired. Accordingly, a set of rules representing a broad range of knowledge can be formed using a number of limited domains, each of which can become fully defined as soon as a sufficient number of examples for each domain is acquired. If it is not possible to define the limited domains in advance, a selection procedure can automatically define the domains as appropriate examples are encountered.

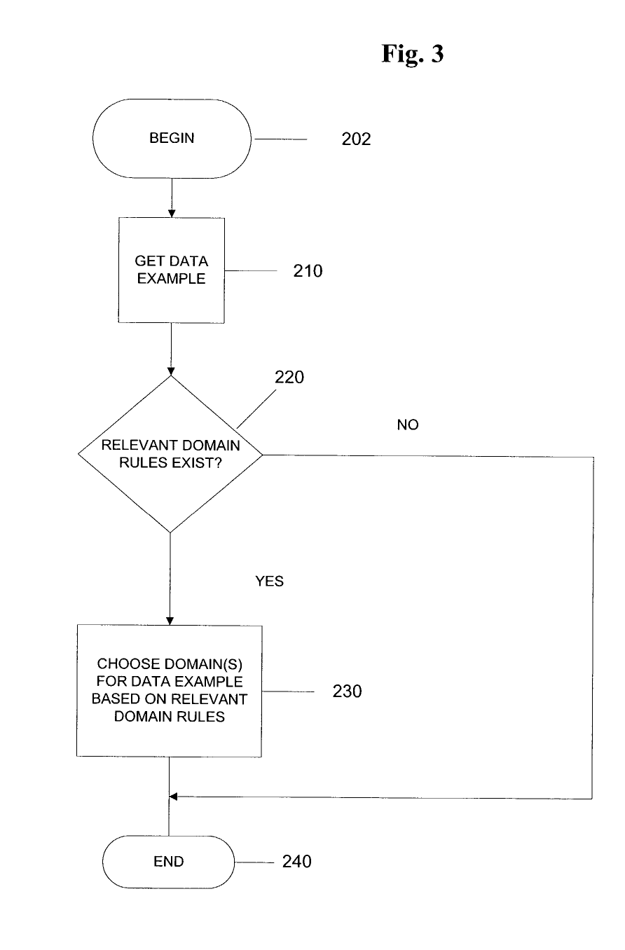

Referring to FIG. 3, a simple illustration of selection of one or more appropriate domains is shown with an entry step 202. The data example obtained in a step 210 is equivalent to that obtained in step 100 shown in FIG. 1. A decision step 220 determines whether a set of rules for assigning attributes and conclusions to appropriate domains exists. If multiple domains exist, and the domain selection rules are formed, the domain(s) appropriate for the data example can be selected, and the data example is then applied to the appropriate domains, as illustrated in a step 230. If multiple domains are not defined, decision step 220 branches to the negative result, and the data example is simply applied to the existing set of rules.

The data examples, often referred to as cases, are records of details, in the form of attribute values, describing events or observations relating to situations occurring in everyday life. From these records, a machine can be configured to execute a programmed method according to the present invention to discover patterns within the data representing those situations and build a knowledge base. The present invention preferably uses the first data example as a first rule. It should be apparent that any data example can be selected as a rule for executing the method according to the present invention.

If multiple domains have been designated as discussed above, then the selected data example forms the first rule of each designated domain. The first rule in each of the domains in this case is preferably formed with only the attributes and conclusions designated for the particular domain according to the domain selection rule set. All other attributes can be marked as irrelevant to the domain, if not discarded. The domain selection rule set is also preferably formed with only the attributes and conclusions needed to select the appropriate domains. If the domain selection rule set is part of a hierarchy having more than two levels, then each domain of all the domain selection rule sets is preferably formed using only the attributes and conclusions necessary to select the appropriate lower level domains. This hierarchical level structure can be repeated for any number of domain levels.

The same attribute may be used in more than one domain, and are used on more than one domain level given a number of hierarchy levels for domains. For example, environmental conditions such as the temperature may influence more than one domain, and may be pertinent to more than one domain level in a domain hierarchy. If the first data example does not contain attributes or a conclusion related to a particular domain, the domain preferably remains in a state associated with waiting for a first data example.

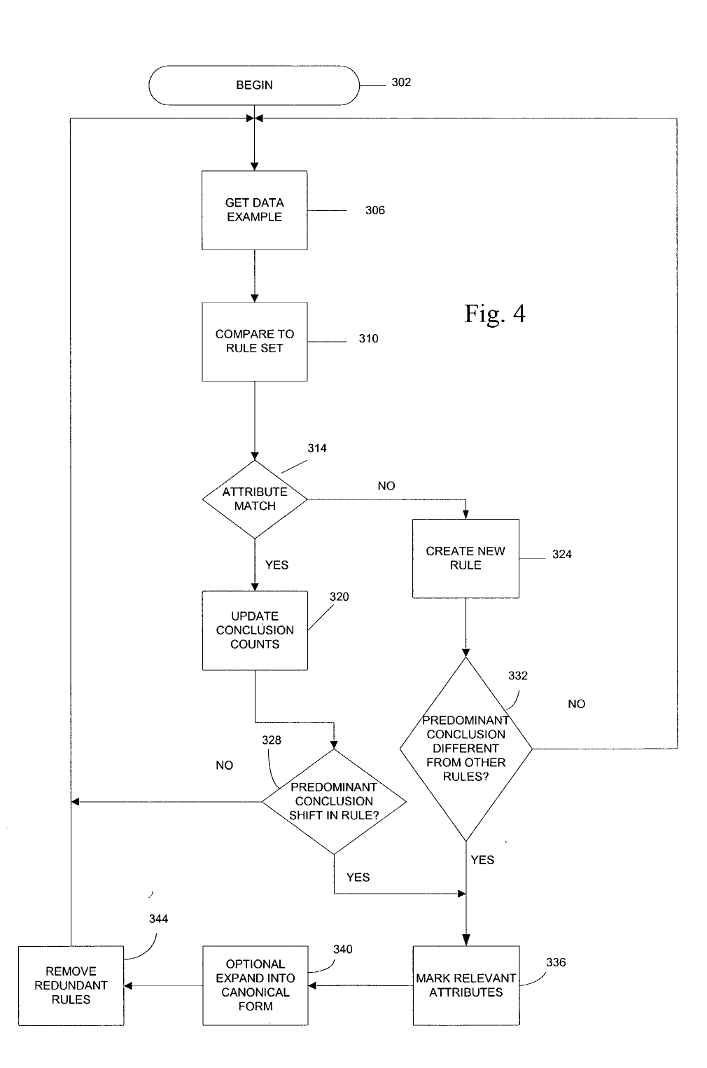

Referring to FIG. 4, a flow diagram illustrating the processing of data examples is shown. Entry to the process is found at a step 302, which is directed to a step 306 in which a data example is obtained. The data example obtained in step 306 can be a real time data example related to instantaneous or very recent events. Alternatively, the data example can be obtained from a sequential list of examples that have been accumulated over a period of time and stored for processing. As new data examples are acquired in step 306, they can be applied to all previously defined domains, as discussed above. The application of a data example to a domain rule set is illustrated in a step 310, in which comparisons between the data example and the appropriate domain rule set takes place. Domains encountering a data example with assigned attributes or conclusions for the first time in step 310 treat the data example as a first rule in the domain. If no domains are defined, the first data example obtained from step 306 is treated as the first rule in the rule set in step 310.

When a domain already has at least one rule, new data examples assigned to that domain are compared to the existing rule(s) in step 310. A decision step 314 determines if the attribute values contained in the new data example match an existing rule for the domain. If an attribute value match between the data example and a rule is obtained, decision step 314 branches to the “YES” path, and the conclusion counts for the matched rule are updated in a step 320 in accordance with the conclusion found in the data example.

If the attribute values contained in the new data example do not match an existing rule in the domain, decision step 314 branches to the “NO” path, where a new rule for that domain is made from the data example in a step 324. A new rule generated from a data example that does not match any existing rule in step 324 has a conclusion count of one (1) for the conclusion associated with the data example and that conclusion is designated as the rule's predominant conclusion. All other counts related to conclusions for the newly formed rule are set to zero.

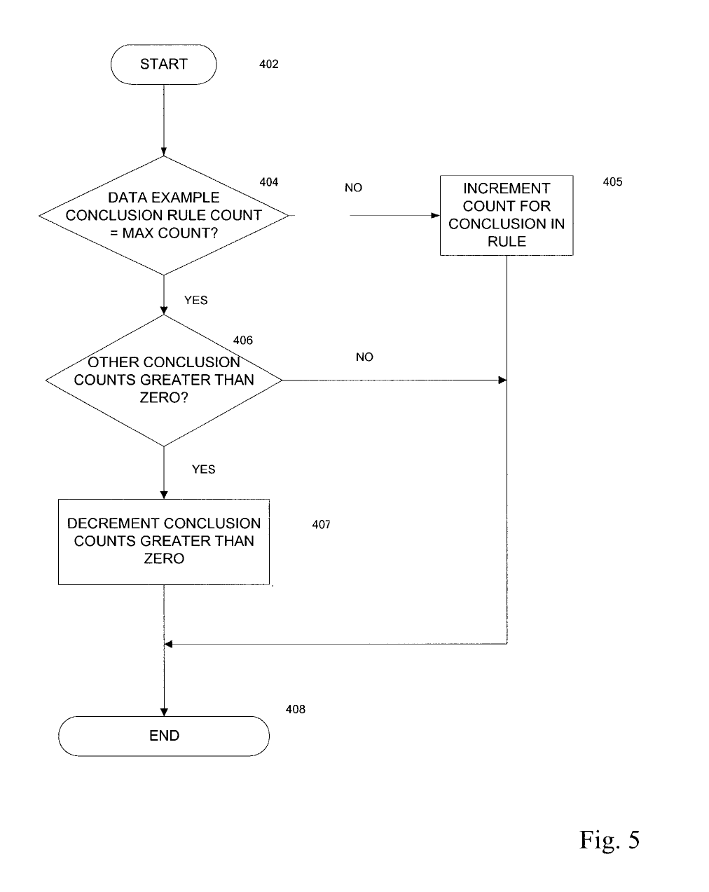

When the conclusion counts are updated in step 320, due to encountering a data example with attribute values that match those of the rule, the rule conclusion counter related to the conclusion found in the data example is typically incremented as shown in FIG. 5, which begins with an entry step 400. A decision step 404 checks if the matching rules's count for the conclusion that matches the conclusion in the data example is at a maximum. If so, the process branches to a decision step 406 that checks for other conclusion counts greater than zero. If other conclusion counts are greater than zero, decision step 406 branches to a step 407, in which those other conclusion counts greater than zero are decremented. If decision step 404 determines that the count for the matching rule conclusion count is not at a maximum, the process branches to a step 405, in which that rule conclusion count is incremented. The various branches of the process complete at a step 408. The maximum value for a conclusion count is chosen based on how quickly a change in data example conclusions are preferably recognized in the set of rules. One maximum value may be selected for the entire system or optimized values may be used for each rule.

This technique of incrementing and decrementing conclusion counts emphasizes the knowledge contained in more recent data examples over that contained in older data examples. Attribute patterns and conclusions that occur with greater frequency in more recently acquired data examples can quickly overcome the rule conclusions that are supported by hundreds of older data examples. For example, setting the maximum conclusion count for a rule to a small number such as, for example, five, enables six new data examples in a row (fewer if the count is non-zero when the string of examples begin) to change the predominant conclusion for the rule. The predominant conclusion is changed if, for example, six data examples containing the same set of attribute values relevant to the rule, having the same previously unencountered conclusion, are assimilated into the rule. The first five of these new conclusions will increment the associated conclusion count to the maximum of five, while with the sixth occurrence of the new conclusion, the previously predominant conclusion count is decremented to a value of at most four. The new conclusion is then designated the predominant conclusion. The designation of predominant conclusion is preferably changed only when a count for a non-predominant conclusion exceeds the count for the designated predominant conclusion to reduce frequent changes. To increase the suppression of frequent changes, the decision to change the designation can be delayed until the largest count exceeds all others by more than one. The condition supporting a change in predominant conclusion depends upon the new data examples having attribute values matching the rule, and having an associated conclusion different than the predominant conclusion. By selecting the maximum conclusion count to be small as illustrated, the resulting emphasis on new data examples permits the predominant conclusion to be rapidly supplanted, even though supported by hundreds of previous data examples.

A shift in the predominant conclusion for a rule indicates that the rule is now associated with the new conclusion. A decision step 328 determines if a shift in the predominant conclusion has occurred. If a shift in the predominant conclusion for a rule has occurred, and there is more than one rule in the domain or rule set, decision step 328 branches to the “YES” path to initiate a sequence to reprocess the existing rules to determine any changes to the relevancy of the rule attributes.

The existing rules are also preferably reprocessed if, for example, a new rule is created in step 324, and the new rule has a conclusion that is different than the predominant conclusions of other rules in the same domain. A decision step 332 checks the conclusion of the newly created rule from step 324, and branches to the “YES” path for reprocessing if the conclusion differs from those of other rules in the domain or rule set. The addition of a new rule with a new conclusion may affect the relevancy of attribute values in other rules in the domain. If the addition of a new rule in step 324 does not result in a conclusion that differs from those of other rules in the domain, the attributes of the rule are all considered relevant to the rule conclusion. This inference is obtained by virtue of the new rule having the same conclusion as all other rules in the domain, and thus providing no insight on irrelevant attributes. Accordingly, decision step 332 branches to the “NO” path to return to the beginning of the process to obtain a new data example. This occurs only when starting a domain and continues until the first example containing a different conclusion is encountered.

When there is a conclusion shift in a rule, or a new rule is added to a domain with a conclusion different from other rules in the domain, the rules must be reexamined to determine the relevancy of all attributes in the rules according to their attribute values. The processing of relevant attributes preferably identifies those attributes that distinguish one situation/concept from another. A step 336 begins the rule reprocessing by identifying the relevant attributes in a rule through comparisons of the attribute values with other rules having different predominant conclusions. The values of attributes that correspond between the rules under comparison are compared with each other, and if any of the attribute values match, meaning that they do not contribute to differentiating the two differing conclusions, then they are marked irrelevant in both the new rule and in the rule to which it is compared. This process continues until all relevant attributes among all of the rules have been identified, as discussed in more detail below.

Once all relevant attributes have been identified for all the rules in the domain in step 336, the rules may be expanded into canonical form in optional step 340. The canonical expansion is used to simplify the identification of redundant rules. For example, two rules that are mutually exclusive because they have differing attribute value patterns may still be redundant in their conclusion or action. If the two rules have the same conclusion, and a common subset of identical attribute values, the rules are redundant. The canonical expansion in step 340 sets up the attribute values in an easily comparable form to identify any existing redundancies. Preferably, when a new rule is generated or a rule is modified by the identification of a relevant/irrelevant attribute through the above process, the rule is rewritten in canonical form. The canonical form is an expansion of the rule resulting in a generalized form that contains relevant attributes and a predominant conclusion.

Each group of rules with the same conclusion is reviewed in a step 344 to eliminate any redundancy that may exist. Once redundancies are eliminated in step 344, the resulting set of rules provides a conclusion for every possible combination of the attributes for its knowledge domain if at least two rules were generated for the domain. If sufficient examples have been provided, the information about the domain represented by the rules will not contain overlap, e.g., the rules will be consistent with each other, and mutually exclusive.

Once the rules have been reprocessed for simplification and optimization in steps 336, 340 and 344, the procedure preferably accepts a new data example for processing, as illustrated by step 306 in FIG. 4. The procedure can continue for as long as data examples are supplied, or can be discontinued and restarted at any point. As discussed above, the procedure can also be applied to an amassed set of data examples to produce a set of rules for that knowledge domain.

The method according to the present invention is preferably suitable for developing personalization rules based on user interaction with a real life system. According to a preferred embodiment of the invention, the rules resulting from application of the method are developed in the following steps:

(1) Format the Data

The data is arranged to focus on a domain of knowledge. The domain of knowledge to be represented by the rules is preferably decided upon by an operator or system developer. The operator preferably selects the conclusions or actions that are of interest for the domain (and any subset domains), and the attributes that are used to describe the situations for which the conclusions of interest apply in the domain (and subset domains). The data is organized into a regular format, or if the data is arriving in real time, it is formatted as it is received. Referring to FIG. 8 momentarily, the data is preferably organized into an ordered set of attribute values, followed by a conclusion associated with the attribute values. Counters for the conclusions are reserved in relation to the rules that are constructed from the data examples. The examples can be sampled, as discussed above with regard to FIG. 2, if there is a concern that data examples with infrequently occurring information may be masked by erroneous data related to frequently occurring conclusions. Preferably, the sampling is conducted to prevent the ratio of the most frequently occurring conclusion to the most infrequently occurring conclusion from exceeding a value based on an assumed or practical error rate. If the number of examples of some of the conclusions is small relative to the number of examples of other conclusions, a fraction of the data examples with more frequently occurring conclusions may be discarded. Discarded data examples can still contribute new information simply through the fact of occurrence and the time of occurrence, which may be recorded for use by the system. When some of the more frequently occurring data examples are discarded, the ratio of the most frequently occurring conclusions to the least frequently occurring conclusions must not exceed a value for which a practical error rate would introduce an erroneous conclusion, if reliable results are to be expected.

(2) Generate an Initial Rule

When a first data example is processed, the attribute values of the data example are used as the attribute values of a first rule in a first rule set. The counter for the respective conclusion found in the data example is set to one, and that conclusion is designated as the predominant conclusion or action for the rule. All other conclusion counters are set to zero. If a number of subset domains are defined, the first data example becomes the first rule in each subset domain in which the associated conclusion is to be represented. Each of the first rules may have attributes omitted or specifically marked as irrelevant according to the subset domain definition, as illustrated in FIG. 3. Some attributes in the example may be known apriori to be relevant in the highest hierarchical level and thus be implicit in the lower level, making their explicit presence unnecessary.

(3) Mark Initial Relevant Attributes

Mark each attribute of the rule, not specifically marked irrelevant by the subset domain definitions, as being relevant to the predominant rule conclusion. Preferably, all the attributes are marked as belonging to a relevant attribute list referred to here as List 1. For example, given three attributes for the rule, a, b and c, List 1 comprises (a, b, c). Marking the attributes as relevant can take the form of a list indicator. Since other rules that may be added to the first rule set can have their associated attribute values included in a number of lists (i.e. List 1, List 2, etc.), relevancy can be shown by inclusion in a list. With the attributes a, b and c, a list of relevancy indicia marks can take the form of (1, 1, 1), meaning that the attributes a, b and c all belong to List 1 and are relevant. A “0” may be used to indicate that an attribute is irrelevant, for example. If subset domains are defined as discussed above, some attributes may initially be specifically marked as irrelevant to simplify processing, with a −1, for example. If not so marked, those attributes would be discovered to be irrelevant by the method if their values are invariant or enough data examples are used.

(4) Generate Initial Final Rule

The rule in the first rule set is preferably expanded into canonical form and placed in a second rule set. Expansion into canonical form produces a number of canonical rules dependent upon the number of relevant attributes in the rule. For n attributes marked relevant, canonical expansion produces n rules. For example, if a, b and c represent three attribute values that are relevant to an associated predominant conclusion A, canonical expansion gives the general rules (a, x, x)=>A, (a′, b, x)=>A, and (a′, b′, c)=>A, where x represents any value, =>means “implies,” and a′ represents “not a“. If a complete rule set is desired, the expansion rule (a′, b′, c′)=>A′, representing the only attribute pattern not already covered, or (a′, b′, c′)=>X can be used where X represents any conclusion including A. Although the rule (a′, b′, c′)=>A′ completes the rule set, it does not necessarily follow from the relevant attribute rule (a, b, c)=>A. When a second rule is generated it will complete the rule set, making the inserted rule redundant. It should be apparent that there may be more than two potential values for each relevant attribute, i.e., a′ represents any other value that the attribute “a” can accommodate. The second rule set made of canonical rules is preferably copied into a third rule set, also referred to as a final rule set. Although the second rule set could serve as the final rule set, it will be seen that it would require additional processing to rebuild modified rules.

(5) Accept Next Example

As further data examples become available, either in real-time or from a stored data set, they are preferably processed in turn to add information to the rule set. The attribute values of a data example available for processing are compared to the corresponding attribute values of the rules in the first rule set and any appropriate subset domains.

(5a) Pattern Already Exists

If the attribute values of the data example match all of the corresponding attribute values contained in a compared rule, the conclusion counter for the rule is updated related to the conclusion found in the data example. If incrementing the counter would exceed a predetermined maximum count; the counter is not incremented, and the counts of the other conclusions or actions for that rule that are greater than zero, are decremented. When the conclusion count is at a maximum and all other conclusion counts are decremented in response to the data example with the matching attribute values, the maximum count conclusion is designated as the predominant conclusion for the rule, if a larger difference is not required (as previously discussed). Since the rules are built to be mutually exclusive with regard to attribute value patterns, once a match for the attribute pattern has been found, the comparison terminates. Once the information contained in the data example is assimilated into the rule through updating the appropriate conclusion count, the data example is no longer needed and can be discarded.

In the case of amassed data records, if it is not desired to place greater importance on the last of the records processed, then any reference to a maximum count can be eliminated, or the maximum count can be set to a very high value.

(5b) Pattern is New

If any of the attribute values of the data example differ from the corresponding attribute values contained in a compared rule, the comparison for that rule is discontinued. Another rule from the first rule set is selected for comparison of the attribute values, and the comparison continues until a match is found, as in (5a) above, or until all the rules are exhausted. When all the rules have been exhausted without an exact match for the attribute values having been found, a new rule is made as in step (2) above. The attribute values of the data example are used as the attribute values of a new rule in the first rule set. The rule conclusion counter for the respective conclusion found in the data example is set to one, and that conclusion is designated as the predominant conclusion or action for the new rule. All other conclusion counters in the new rule are set to zero. By forming a new rule with an attribute value pattern that does not match that of any other rule, the rule set is assured to be mutually exclusive. This process is repeated for any appropriate subset domain.

6) Mark relevant attributes

There are at least two conditions when a review of the rules is preferably done to identify relevant and irrelevant attributes as shown in steps 328 and 332 in FIG. 4. If a new rule with a predominant conclusion or action different from those of the other rules in the domain is formed through the above process, a review of the rules is preferably conducted. In addition, when the predominant conclusion or action of a rule switches from one conclusion to another through updated conclusion counts, and there is more than one rule in the domain or rule set, a review of the rules is preferably conducted. The changes in the conclusions for the rules in the rules set can indicate that the relevancy of some attributes with respect to their associated conclusions has changed. The review or reprocessing of the rules is conducted to properly identify irrelevant or newly relevant attributes in the rules. However, it is not necessary to perform the review or reprocessing of the rules immediately. If in a real-time system the input data rate temporarily out-strips the processing capacity, the review or reprocessing can be delayed until the data rate permits the review or reprocessing to take place without impairing the ability to collect real-time data. Delaying the processing does not impair the final result.

(6a) New Rule Generated

The rule processing calls for all the attributes, except those specifically marked irrelevant, of any new rules generated in (5b) to be marked as relevant by belonging to a relevant attribute List 1 of that rule. For example, if the rule has attributes (a, b, c, d), indicia marks are provided with respect to the relevancy of the attributes: (1, 1, 1, 1). The attribute values of the new rule are compared to the attribute values of every rule in the first rule set that has a predominant conclusion different from that of the new rule. A copy of the indicia marks for the compared rule is made prior to the rule comparison. Usually, a copy of the indicia marks for both rules is made prior to the comparison in case the indicia marks need to be restored if the comparison results in all relevant attributes being declared irrelevant. However, a copy of the new rule need not be made for the first comparison, since there will be at least one relevant attribute remaining after the comparison as a result of building mutually exclusive rules.

As each attribute value in the new rule is compared to the corresponding attribute value in an existing rule with a different predominant conclusion, any matching attribute values indicate that those attribute values are irrelevant to the conclusions in their respective rules. This result is logically supported because the matching attribute values do not differentiate between the two rules having different predominant conclusions.

Accordingly, when a match occurs, the indicia for the matching attribute values is changed to irrelevant to record the comparison result. For example, if a rule has a list of attributes (a, b, c, d), a typical relevant indicia list might be (0, 1, 2, 2). Here, 0 indicates that attribute ‘a’ is irrelevant, 1 indicates that attribute ‘b’ belongs to attribute List 1, and the 2's show that attributes ‘c’ and ‘d’ are in attribute List 2. The procedure for developing the various Lists is discussed more fully below. It is possible to have a number of Lists for each rule, and the combination of the irrelevant attributes and the various Lists represents all of the attributes in the rule. Each attribute in a rule belongs to one of the Lists of relevant attributes or is marked irrelevant (e.g. 0 or −1).

(6a1) At Least One Relevant Attribute

For each rule in each comparison between two rules, the comparison can result in at least one attribute in the rule remaining marked relevant. In this instance, the relevancy marks contained in the lowest numbered List in which at least one relevant attribute is found are retained. The other relevant attribute value marks are restored from their copies made prior to the comparison and subsequent relevancy mark changes.

In the example with attributes (a, b, c, d), and respective relevancy marks (0, 1, 2, 2), suppose that the relevancy marks for attributes ‘b’ and ‘d’ are both changed to 0, i.e., marked irrelevant as a result of the comparison. The new relevancy indicia list for that rule becomes (0, 1, 2, 0). Here, attribute ‘a’ remains irrelevant. Attribute ‘b’ is a member of List 1, since List 1 has no remaining relevant attributes, and is restored from the List 1 copy. Attribute ‘c’ is the only remaining relevant attribute in List 2, with ‘d’ being declared irrelevant. Accordingly, List 2 (attribute ‘c’) is retained in its simplified form as indicated by the indicia mark ‘2’ in the location indicative of attribute ‘c’. If there were a List 3 containing none, one, or more remaining relevant attributes, it would also be restored from its copy because it has a List number that exceeds that of List 2, and List 2 had a relevant attribute left after the comparison concluded.

(6a2) All Attributes Declared Irrelevant

If all the attributes of the rule become marked irrelevant as a result of the comparison, the relevancy indicia marks for that rule are restored from the copies made prior to the comparison. The values of the irrelevant attributes that do not match the values of the corresponding attributes to which they are compared are then marked as belonging to a new relevant attribute List. The new relevant attribute List is numbered as the next higher number in the order of relevant attribute Lists, i.e. 2, 3, 4, etc.

For example, given the initial scenario described above with relevancy indicia marks of (0, 1, 2, 2), if the marks for ‘b’, ‘c’, and ‘d’ are changed to 0 (irrelevant) as a result of the comparison, the new relevancy indicia marks for that rule becomes (3, 1, 2, 2). Since all the relevancy indicia marks are changed to 0 (irrelevant) in this scenario, Lists 1 and 2 are brought back from their copies, reestablishing the relevancy indicia marks for attributes ‘b’, ‘c’ and ‘d’. Attribute ‘a’, found to be mismatched, is made part of a newly formed List 3, which is the next sequential number for attribute Lists. When the relevancy indicia marks are brought back from their copies, there will always be at least one attribute available for a new attribute List. The available attribute results from the rules all being mutually exclusive, and logically, there is at least one attribute that has a different value than that of the corresponding attribute in the compared rule. The mutual exclusivity of the rules is assured from the operations provided in (5b).

(6b) Change in Predominant Conclusion for a Rule

If the predominant conclusion of a rule changes from one action to another in (5a), and there is more than one rule in the domain, a rule reprocessing for relevant attributes is contemplated. All of the rules having a predominant conclusion matching that of the new, changed predominant conclusion are compared to all the rules in the domain that have a different predominant conclusion. Two scenarios are contemplated in this comparison, (1) comparing the rule that has the switched predominant conclusion to the rules with (now) different predominant conclusions, and (2) comparing the rule(s) with predominant conclusions now matching the predominant conclusion of the changed rule to the rules with different predominant conclusions.

(6b1) Compare Changed Rule

The rule that has the changed predominant conclusion is compared against all other rules in the domain having predominant conclusions that differ from the new predominant conclusion of the changed rule. The changed rule is treated as a new rule and processed as provided in (6a). The difference is that some rules preferably do not have their relevancy indicia marks modified. The changed rule and the rules that have a predominant conclusion matching that previously held by the changed rule are preferably allowed to have their indicia marks modified, while the relevancy indicia marks of all other rules preferably do not change with the comparison.

The relevancy indicia marks of rules that have a predominant conclusion that matches neither the new nor the previous predominant conclusion of the changed rule preferably remain the same. Accordingly, it is not necessary to make copies of the relevancy indicia marks for these compared rules prior to a comparison. If the changed rule is compared against a rule that has a predominant conclusion that matches that previously held by the changed rule, then the relevancy indicia marks of both rules can be modified. When a situation is encountered where the relevancy indicia marks for a rule can be modified, a copy of the marks is made prior to the comparison, in case the marks need to be restored by changes due to irrelevancy, as indicated in (6a).

(6b2) Compare Other Rules With Same Conclusion

The rules in the domain that have a predominant conclusion that is the same as that of the new predominant conclusion for the changed rule are reviewed to check for relevancy as well. These reviewed rules are compared to all other rules in the domain that have differing predominant conclusions. Each of these reviewed rules is treated as a new rule and processed as provided in (6a). The relevancy indicia marks of the rules to which the reviewed rules are compared preferably are not modified as a result of the comparison. Accordingly, copies of the relevancy indicia marks for the rules to which the reviewed rules are compared are not required. However, copies of the relevancy indicia marks for each of the reviewed rules under comparison are preferably made prior to the comparison.

Changing a predominant conclusion can institute a number of rule comparisons according to this process (as many as N(n−1) for n rules of which N belong to the set of rules having the predominant conclusion of the new predominant conclusion of the changed rule). Accordingly, it may be preferable to delay recognition of the predominant conclusion change until the associated conclusion count exceeds the other conclusion counts by more than one count to avoid unnecessary computation. If it is known that the data is noisy, with a variance of δ² for example, then a change of 2δ might be used as the delay threshold before recognizing the new predominant conclusion. The delay threshold preferably does not require the prior predominant conclusion count to be decremented below zero due to the recognition delay.

(7) Generate final rules

When relevancy indicia marks of any rule in the first rule set are created or changed, the new and modified rules of the first rule set are preferably expanded into canonical rules in the second rule set. The new and modified canonical expansion rules preferably replace any previous versions for those rules in the second rule set. The changes in the canonical rules are then preferably incorporated into a third rule set that contains the final rules describing the domain without redundancies among the rules.

(7a) New Final Rule

If a new rule is generated in (5b) and no other rules in the first rule set have had their relevancy indicia marks modified in (6), the new rule is preferably expanded into canonical form (one or more rules that represent the rule) and placed in the second and third rule sets. In the third rule set, rules that have the same conclusion as the new rule are examined and redundant rules are preferably removed. In addition, the non-redundant rules in the third rule set are examined to determine if rules can be combined in a more generalized form that permits the elimination of an attribute.

For example, a domain's third rule set with information represented by three attributes, (a, b, c) could have a rule [1] with an attribute set of (x, b, x). The set (x, b, x) can by broken down into the subsets (a, b, x) and (a′, b, x), where x is an attribute placemarker that represents any value of the attribute and a′ represents “not a”. If there is a rule [2] with the same conclusion and with an attribute set of (a, x, x), it can be broken down into the subsets (a, b, x) and (a, b′, x). Accordingly, the subset (a, b, x) can be deleted from rule [1], since it is redundant to that in rule [2]. Rules [1] and [2] are therefore completely represented by the sets (a, x, x) and (a′, b, x). Alternately, this resultant rule pair (a, x, x), (a′, b, x) can be rewritten as rules (a, b′, x), (x, b, x) if needed, to combine the attribute sets with that of another rule.

(7b) Change in Relevancy Indicia Marks

If there is a change in the relevancy indicia marks for any rules in the first rule set as provided in (6), then the rule(s) with the changes are preferably expanded into canonical form rules in the second rule set, replacing any prior canonical form version of those rules. All the rules in the third rule set with the same action as the changed rule(s) are preferably deleted and recreated from the second rule set. The third rule set will then be consistent with the modified rule(s) in the second rule set. The third rule set is then examined to remove redundant rules and combine rules that enable elimination of an attribute as discussed above.

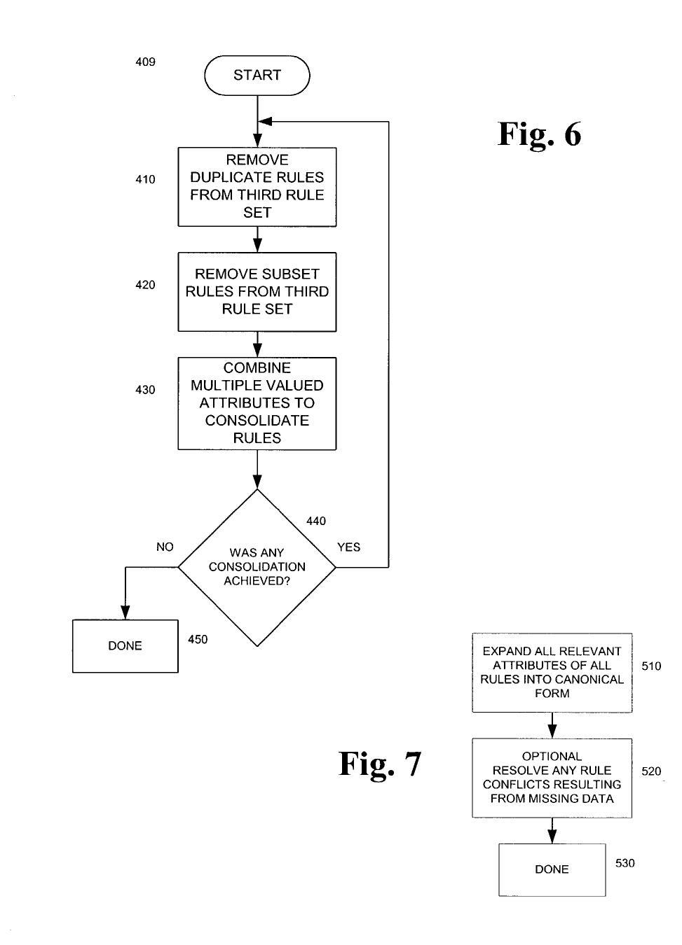

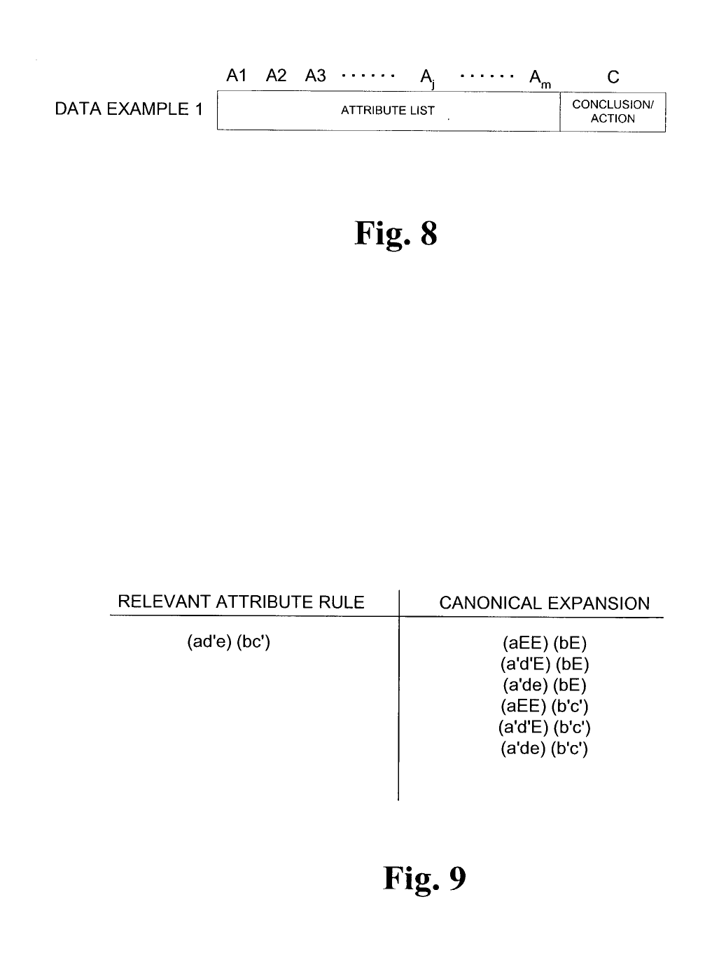

In addition, the combination of rules can occur through grouping of multi-valued attribute values. For example, an attribute can represent several different values of a multi-valued attribute in combination with other rules. If two rules with the same action in the third rule set match exactly except for having different values for one multi-valued attribute, the two rules can be combined into one rule. The attribute values of that attribute of both rules are preferably grouped together, excluding duplicate attribute values. The result is a single rule containing all the relevant attributes of the previous two rules, with the differing values of the multi-valued attribute being grouped to act as a single attribute. For example, if attribute ‘g’ has the relevant values 1, 3, 5 in one rule and 1, 2 in another rule with the same conclusion, one rule can be deleted and ‘g’ in the retained rule would now have relevant values 1, 2, 3, 5. If the group of values for the multi-valued attribute contains all the possible values for that attribute, then the attribute can be deleted from the rule as being irrelevant. This result is observed since the values of the multi-valued attribute do not contribute to distinguishing between the combined rules. FIG. 6 illustrates a process for consolidating rules according to the present invention.

(8) Reporting

This section provides an optional action that can be taken as a result of observing the rule outcomes. Referring to FIG. 7, If there are any gaps in the domain information not covered by the rules, an operator can be notified in an optional step 520. Some steps an operator might take upon notice of gaps in the rules can be to acquire more specific data examples related to filling in the information. In addition, if there is any overlap between rules having different conclusions, conflicting rules, further sampling to provide particular data examples can dispel the overlap. In addition to taking specific data examples or new samples, an expert on the domain of knowledge can decide on how any conflict between the rules should be resolved. All information regarding the domain of knowledge can be recorded for later use in resolving conflicts. An operator may be able to better distinguish redundant rules after all relevant attributes of all the rules are expanded into canonical form, as illustrated in step 510.

The system and method of the present invention provides a complete and consistent rule set for the domain of knowledge under observation as long as enough data is provided. The first operation in the process organizes the incoming data, either real-time or stored, for the succeeding operations. The second operation initiates processing by reviewing the first data example and creating the first rule of the first rule set. With the first rule there is no knowledge domain information with which to compare the relevance of the information. Lacking any contrary information, each attribute of the first rule is preferably marked relevant in the third operation. The relevancy indicia marks indicate that the attributes all belong to one (the first) relevant attribute List. Further operations can introduce new sequentially numbered relevant attribute Lists, each having relevant attributes related to a subset of data examples. With each new rule placed in the first rule set through subsequent operations, the totality of relevant attribute Lists in all of the rules cover (represent) all the data examples, even though some attributes may be completely omitted from the relevant attribute Lists (they are determined by the process to be irrelevant).

The fourth operation completes the initial processing of the first rule in the first rule set. The rule is preferably expanded into canonical form and placed in the second rule set. Since the rule is already in reduced form (there are no other rules), it is also placed into the third rule set. Subsequent operations preferably use the second rule set as an intermediate location for canonical rules. The third rule set becomes the final product of the system and method of the present invention. Each of the rules in the third rule set represents the intelligence or knowledge evidenced by the information contained in the data examples.

The further operations handle subsequent data examples in a manner similar to that described in the above operations. Operations 5-7 are similar to 2-4, with the exception that operations 2-4 are initialization steps. It should be apparent that operations 2-4 and 5-7 can readily be combined into a series of general case operations. That is, while operations 2-4 represent an initialization phase in the above described process, these operations can simply be incorporated into operations 5-7, so that operation 5 accepts a first data example and so forth. The first data example can simply be treated as a new rule in operation (5b), and the process can continue with the appropriate operations.

Each new data example is preferably processed through all of the operations 5-7 prior to accepting the next data example. If the rate of accepting data is very high in comparison to the speed, at which the current data example is processed, input data might have to be queued. It is possible to sample the data examples received to avoid having information queued, or if the system is to provide real-time results without a large lag time. When there are a large number of certain data examples that threaten to overwhelm the importance of less frequently occurring data examples due to the magnitude of the data error rate, a fraction of the more frequently occurring data examples may be discarded; thus reducing processing and suppressing erroneous conclusions. Another strategy to handle high input data rates is to delay the processing of operation 6, particularly 6b, during periods of high input data rates.

Operation (5) preferably assures that new rules are added to the first rule set only if the new rule is mutually exclusive of all the other rules in the first rule set. If the new data example matches any rule, the conclusion count for that rule is modified such that the predominant conclusion count never exceeds a predetermined maximum.

Operation (6a) considers newly created rules in the first rule set, separating the attributes of the rule into relative attribute Lists. Attributes that are irrelevant to the predominant conclusion of the rule are so marked, while relevant attributes are placed in relevant attribute Lists that distinguish that rule from all the other rules having a different predominant conclusion. The relevant attribute Lists for the rule are preferably organized into relevancy indicia marks for that rule that show the relevancy of attributes and the relevant attribute List to which the attribute belongs, if any. The convention of using relevant attribute lists permits modification of the rules in a structured format, as needed upon comparison to another rule with a different predominant conclusion. Each relevant attribute List differentiates the rule from a subset of the other rules. Attributes that are not required in making these distinctions are recognized as irrelevant and can be excluded from the attribute lists in the final rules formed in operation (7).

Operation (6b) considers changes made to the relevancy indicia marks for rules in the first rule set when the predominant conclusion of a rule is modified through exposure to the information in a new data example. The relevancy indicia marks for rules having the prior and changed predominant conclusion are preferably modified, while the marks for other rules remain unchanged.

The seventh operation completes the rule generation process for each new data example encountered. The procedure loops back to Step 5 to continue processing new data examples. If the relevancy indicia marks of a rule are modified in operation (6), the rule is expanded into a canonical form and preferably replaces prior versions of the rule in the second rule set. The rules in the second rule set are copied into the third rule set and examined to reduce or consolidate the rules if possible. The canonical form of new rules are also preferably placed in the third rule set, and examined with other rules having the same predominant action to reduce or consolidate the rules if possible. The rules in the third rule set are examined for inconsistencies or redundancies, and made consistent if possible.

The third rule set is the final output of the system; accurately representing the intelligence contained in the data examples presented to the system. These rules can be used in an expert system to supply the appropriate response for situations covered by the domains of knowledge from which the data examples were derived. By comparing new data to just the relevant attributes of these rules, the action or conclusion for the rule that matches the new data can be inferred by the expert system to be the most appropriate action or conclusion to draw. One basis for this result is that the data examples used to develop the rules consistently represent the best course of action, given their particular attribute value pattern.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for formulating a set of rules, comprising:
a) receiving data related to a situation, said data comprising a received attribute value pattern and an associated conclusion;
b) comparing said received attribute value pattern to all other attribute value patterns in said set of rules that are associated with conclusions different than that of said received data to identify matched attribute values between said received attribute pattern and said compared attribute patterns;
c) marking said matched attribute values as irrelevant in said received attribute pattern and said compared attribute patterns; and
repeating a) through c) to form and update said set of rules, with each rule comprising a relevant attribute pattern and an associated rule conclusion.

2. The method for formulating a set of rules according to claim 1, further comprising initially marking said received attribute values as relevant.

3. The method for formulating a set of rules according to claim 1, further comprising placing said received attribute value pattern and associated conclusion in said set of rules if said received attribute value pattern is not already in said set of rules.

4. The method for formulating a set of rules according to claim 1, further comprising:
designating as a first list all attributes of said received attribute pattern prior to b);
making copies of said first list, and any subsequent lists, of said received attribute pattern and said compared attribute patterns prior to b);
replacing after c) all lists in said received attribute pattern and said compared attribute pattern with their respective copies except for the lowest numbered designated list containing at least one said attribute marked relevant; and
when no list in said received attribute pattern and/or said compared attribute pattern contains at least one attribute marked relevant, designating as a second (third, fourth, . . . as appropriate) list all attributes in said received attribute pattern and/or said compared attribute pattern whose values do not match, marking said values as relevant, and replacing all other lists in said received attribute pattern and/or said compared attribute pattern with their copies.

5. The method for formulating a set of rules according to claim 1, further comprising removing redundant rules from said set of rules.

6. The method for formulating a set of rules according to claim 1, wherein said received data can be selectively discarded and further data can be received to thereby increase the relative frequency of occurrence of an infrequently occurring conclusion in said received data.

7. The method for formulating a set of rules according to claim 1, further comprising initializing said set of rules with an initial received attribute pattern and an associated conclusion.

8. The method for formulating a set of rules according to claim 1, further comprising:
determining if said received attribute value pattern matches any other attribute value pattern in said set of rules;
incrementing a conclusion count in said compared rule having a matching attribute value pattern; and
creating a new rule in said set of rules from said received attribute value pattern and said associated conclusion if said received attribute value pattern matches none of said attribute value patterns in said set of rules.

9. The method for formulating a set of rules according to claim 8, wherein said incremented conclusion count in said compared rule is related to said received associated conclusion.

10. The method for formulating a set of rules according to claim 8, further comprising designating a conclusion of a rule as a predominant conclusion for said rule based on said conclusion count.

11. The method for formulating a set of rules according to claim 1, further comprising designating a conclusion of a rule as a predominant conclusion for said rule based on relevant knowledge about said situation.

12. The method for formulating a set of rules according to claim 1, further comprising expanding each rule in said set of rules into a canonical form.

13. The method for formulating a set of rules according to claim 5, further comprising expanding each rule in said set of rules into a canonical form.

14. The method for formulating a set of rules according to claim 8, further comprising:
setting a maximum conclusion count value;
preventing said conclusion count from being incremented to a value greater than said maximum conclusion count value; and
decrementing all other conclusion counts greater than zero if said conclusion count has a value equivalent to said maximum conclusion count value.

15. The method for formulating a set of rules according to claim 14, further comprising designating a conclusion of a rule as a predominant conclusion for said rule based on said conclusion count.

16. The method for formulating a set of rules according to claim 15, further comprising:
determining if said new rule includes a conclusion different from predominant conclusions found in any other rule; and
processing said new rule with each rule in said any of other rules having a different predominant conclusion according to b) and c).

17. The method for formulating a set of rules according to claim 15, further comprising:
determining if there is a change in a predominant conclusion for said compared rule as a result of changes in a conclusion count for said compared rule; and
if said predominant conclusion changes in said compared rule as a result of changes in its conclusion count:
marking all attribute values relevant in rules having a predominant conclusion equal to the conclusion to which said compared rule changed; and
processing according to b) and c) all rules having a predominant conclusion equal to the conclusion to which said compared rule changed.

18. The method for formulating a set of rules according to claim 1, further comprising:
designating a plurality of domains, each containing a set of rules; and
applying a) through c) to each set of rules in each domain.

19. The method for formulating a set of rules according to claim 18, wherein at least one domain can be completely defined upon receipt of sufficient data.

20. The method for formulating a set of rules according to claim 18, wherein application of a) through c) to each set of rules in each domain takes place simultaneously.

21. The method for formulating a set of rules according to claim 18, further comprising developing a set of domain selection rules for determining a subset of domains for which said received data is applicable.

22. The method for formulating a set of rules according to claim 21, further comprising applying a) through c) to said set of domain selection rules to produce a complete and consistent set of domain selection rules.

23. The method for formulating a set of rules according to claim 18, wherein designating said domains is achieved through selection of attributes represented by said domains.

24. The method for formulating a set of rules according to claim 21, wherein:
at least one domain selection rule in said set of domain selection rules has an attribute corresponding to an attribute value in said received attribute pattern; and
said method further comprises selecting a domain for which said received data is applicable based on said at least one domain selection rule having said corresponding attribute.

25. The method for formulating a set of rules according to claim 1, further comprising at least one multi-valued attribute in said received data having more than two possible values.

26. The method for formulating a set of rules according to claim 1, further comprising:
expanding each rule in said set of rules into a canonical form to form a set of canonical rules; and
removing redundant canonical rules from said set of canonical rules.

27. The method for formulating a set of rules according to claim 25, further comprising:
expanding each rule in said set of rules into a canonical form to form a set of canonical rules; and
removing redundant canonical rules from said set of canonical rules.

28. The method for formulating a set of rules according to claim 27, wherein canonical rules that match except for differing values of one said multi-valued attribute can be combined by grouping said differing values of said multi-valued attribute within a single rule.

29. A system for formulating a set of rules, comprising:
a data input for receiving data;
said data comprising sequential datagroups each comprising an attribute value pattern and an associated conclusion related to a situation;
a processor operable to process said data to form said set of rules comprising a rule attribute value pattern and a predominant conclusion;
said processor being further operable to apply each input datagroup to said set of rules to thereby incorporate information related to said situation into said set of rules;
said processor being further operable to identify attribute values from each rule attribute value pattern that are irrelevant to said associated predominant conclusion; and
said processor is further operable to remove redundant rules from said set of rules to provide a complete and consistent minimal rule set.

30. The system for formulating a set of rules according to claim 29, wherein said processor is further operable to selectively discard some of said datagroups to thereby increase a relative frequency of occurrence of an infrequently occurring situation.

31. The system for formulating a set of rules according to claim 29, wherein said processor is operable to select a predominant conclusion for each rule based on a specified criteria.

32. The system for formulating a set of rules according to claim 31, wherein said specified criteria is provided by an expert.

33. The system for formulating a set of rules according to claim 29, wherein said processor is operable to expand said set of rules into a canonical form before said redundant ones of said rules are removed.

34. The system for formulating a set of rules according to claim 29, further comprising:
a comparator module coupled to said processor and operable to provide a comparison between a selected rule attribute value pattern and all other rule attribute value patterns having predominant conclusions different than that of said selected rule attribute value pattern; and
said processor is further operable to identify said attribute values that match as irrelevant in said selected rule attribute pattern and said compared rule attribute patterns.

35. A computer readable memory storing a program code executable to form a set of rules, said program code comprising:
a) a first code section executable to receive data related to a situation, said data comprising a received attribute value pattern and an associated conclusion, said values initially identified as relevant;
b) a second code section executable to compare said received attribute value pattern to all other attribute value patterns in said set of rules that are associated with conclusions different than that of said received data to match attribute values between said received attribute pattern and said compared attribute patterns;
c) a third code section executable to identify said attribute values that match as irrelevant in said received attribute pattern and said compared attribute patterns; and
d) a fourth code section executable to branch to a) thereby permitting repetition of a) through c) to form and update said set of rules, with each rule comprising a relevant attribute pattern and an associated rule conclusion.

36. The program code according to claim 35, further comprising a fifth code section executable to remove redundant rules from said set of rules.

37. A method for forming a set of rules, comprising:
finding all non-redundant fact patterns in a stream of data related to a corresponding set of situations;
identifying at least one attribute in each fact pattern that contributes to a respective conclusion associated with said fact pattern; and
forming said set of rules using said identified attributes and said respective associated conclusions.

38. The method for forming a set of rules according to claim 37, further comprising removing redundancies within said set of rules.

39. The method for forming a set of rules according to claim 37, wherein said stream of data is sampled to have a first conclusion in a reduced ratio with respect to a second conclusion.

40. The method for forming a set of rules according to claim 37, wherein:
each said fact pattern is associated with a group of conclusions; and
said method further comprises selecting a single conclusion from each of said groups as said respective associated conclusion.

41. The method for forming a set of rules according to claim 38, wherein said rules are expanded into a canonical form prior to removing redundancies.

42. A carrier medium containing a program code executable to form a set of rules, said program code comprising:
a first code section executable to receive data related to a situation, said data comprising a received attribute value pattern and an associated conclusion, said values initially identified as relevant;
a second code section executable to compare said received attribute value pattern to all other attribute value patterns in said set of rules that are associated with conclusions different than that of said received data to match attribute values between said received attribute pattern and said compared attribute patterns;
a third code section executable to identify said attribute values that match as irrelevant in said received attribute pattern and said compared attribute patterns; and
a fourth code section executable to cause repeated execution of said first through said third code sections to form and update said set of rules, with each rule comprising a relevant attribute pattern and an associated rule conclusion.

43. A processor operable to execute a program code from a storage memory to form a set of rules, said program code comprising:
a first code section executable to receive data related to a situation, said data comprising a received attribute value pattern and an associated conclusion, said values initially identified as relevant;
a second code section executable to compare said received attribute value pattern to all other attribute value patterns in said set of rules that are associated with conclusions different than that of said received data to match attribute values between said received attribute pattern and said compared attribute patterns;
a third code section executable to identify said attribute values that match as irrelevant in said received attribute pattern and said compared attribute patterns;
a fourth code section executable to cause repeated execution of said first through said third code sections to form and update said set of rules, with each rule comprising a relevant attribute pattern and an associated rule conclusion; and
a fifth code section executable to remove redundant rules from said set of rules

44. A method for formulating a set of rules comprising:
receiving a stream of data records, each data record containing a set of attributes values and an associated conclusion related to a situation;
forming a first set of mutually exclusive attribute value patterns from said data records, each attribute value pattern being associated with a respective conclusion group containing at least one conclusion;
maintaining a conclusion count for each conclusion in said conclusion group;
forming a second set of attribute value patterns from said first set, each attribute value pattern in said second set being associated with a preferred conclusion chosen from said respective associated conclusion group, said attribute value patterns in said second set containing attribute values relevant to said preferred conclusion, said second set of attribute value patterns being formed by:
a) creating in said second set a copy of a selected attribute value pattern with an associated preferred conclusion from said first set;
b) comparing values of said selected attribute value pattern to corresponding values of all other attribute value patterns in said first set having associated preferred conclusions different from said associated preferred conclusion of said selected attribute value pattern thereby identifying any attributes of said selected attribute value pattern that match as irrelevant to said situation;
c) marking said irrelevant attributes from said copied selected attribute value pattern in said second set; and
repeating a), b) and c) for each attribute value pattern in said first set to form said second set of attribute value patterns comprising said set of rules.

45. The method for formulating a set of rules representing said situations according to claim 44, further comprising sampling said stream of data records to increase a relative occurrence frequency of an infrequently occurring conclusion.

46. A method for formulating a set of rules comprising:
receiving data records, each data record containing a set of attributes values forming an attribute value pattern and an associated conclusion representing a situation;
forming from said records a first set of mutually exclusive attribute value patterns, each pattern being associated with a conclusion group containing at least one conclusion, said first set of attribute value patterns being formed by:
a) placing an initial attribute value pattern and associated conclusion into said first set of attribute value patterns, said initial associated conclusion being placed in an associated conclusion group, and initializing a first conclusion count for said initial associated conclusion placed in said first conclusion group;
b) reading another attribute value pattern and associated conclusion from another received data record;
c) comparing said another attribute value pattern to attribute value patterns in said first set of attribute value patterns;
d) adding said another attribute value pattern and associated conclusion into said first set of attribute value patterns if said another attribute value pattern matches none of said attribute value patterns in said first set of attribute value patterns, said another associated conclusion being placed in another conclusion group associated with said another attribute value pattern added to said first set of attribute value patterns, and initializing another conclusion count for said another associated conclusion in said another associated conclusion group;
e) adjusting conclusion counts in said conclusion group associated with a matched attribute value pattern if a match between said another attribute value pattern and an attribute value pattern in said first set of attribute value patterns is found; and
repeating b) through d) thereby forming said first set of mutually exclusive attribute patterns.

47. The method for formulating a set of rules according to claim 46, wherein said adjusting conclusion counts further comprises:
setting a maximum conclusion count value for said conclusion counts;
incrementing a conclusion count for a conclusion in said conclusion group that matches said another conclusion if said conclusion count is less than said maximum count;
decrementing all other conclusion counts greater than zero in said conclusion group if said conclusion count is at said maximum conclusion count value; and
designating as a predominant conclusion of said conclusion group the conclusion associated with its said conclusion count when said conclusion count exceeds all other conclusion counts associated with said conclusion group.

48. The method for formulating a set of rules according to claim 47, further comprising identifying irrelevant attributes in each attribute value pattern in said first set of attribute value patterns if said another attribute value pattern with a conclusion different from any predominant conclusions in said first set of attribute value patterns is added to said first set of attribute value patterns or if said adjustment in said conclusion counts leads to a changed predominant conclusion when there is more than one attribute value pattern in said first set of attribute value patterns.

49. The method for formulating a set of rules according to claim 48, further comprising:
designating as a first list all attributes of an attribute value pattern being added, said attributes of said list being designated as relevant;
comparing said added attribute value pattern to all other attribute value patterns in said first set of attribute value patterns having different associated predominant conclusions;
identifying said irrelevant attributes as those attributes with matching values in corresponding attributes to which they are compared, said irrelevant attributes being designated as irrelevant;
restoring attribute designations from a copy of a list if all attributes of said list in said added attribute value pattern or said compared attribute value pattern are designated as irrelevant; and
creating a new list if all lists of said added attribute value pattern or said compared attribute value pattern are designated as irrelevant, said new list containing only attributes that do not match, designating said attributes of said new list as relevant.

50. The method for formulating a set of rules according to claim 48, further comprising:
replacing said lists designating relevancy of attributes of each attribute value pattern having a predominant conclusion the same as said changed predominant conclusion with a first list of all attributes of said attribute value pattern, said attributes of said list being designated as relevant;
comparing said attribute value patterns associated with conclusions that are the same as said changed predominant conclusion to all other attribute value patterns having different associated predominant conclusions in said first set of attribute value patterns;
identifying said irrelevant attributes as those attributes with matching values in corresponding attributes to which they are compared, said irrelevant attributes being designated as irrelevant;
restoring attribute designations from a copy of a list if all attributes of said list in an attribute value pattern are identified as irrelevant; and forming a new list for an attribute value pattern of its attributes that do not match if all attributes in all said lists of said compared attribute value pattern are identified as irrelevant.

51. The method for formulating a set of rules according to claim 50, wherein said attribute value pattern having a changed predominant conclusion is compared to all patterns having a predominant conclusion different from said attribute pattern and only retaining copies of said lists of said attribute value pattern having a changed predominant conclusion and said lists of attribute value patterns having predominant conclusions the same as said attribute value pattern before said change.

52. The method for formulating a set of rules according to claim 50, wherein said attribute value patterns having predominant conclusions the same as said changed predominant conclusion, excluding said attribute value pattern having a changed predominant conclusion, are compared to all patterns having a predominant conclusion different from said attribute value pattern;
retaining copies only of said lists for said attribute value patterns for restoring attribute designations; and
stopping for each said attribute pattern when said attribute value pattern list matches a former list.
